(19) United States
(12) Patent Application Publication
(10) Pub. No.: US 2026/0320558 A1
(43) Pub. Date: Oct. 15, 2026

(54) SYSTEM AND METHOD FOR ACTION ITEM MANAGEMENT FOR SPREADSHEET INTERFACE INTEGRATED WITH WEB SERVICE

(71) Applicant: ORACLE INTERNATIONAL CORPORATION, Redwood Shores, CA (US)

(72) Inventors: Shaun Logan, Melrose, MA (US); Edmund Alex Davis, San Mateo, CA (US)

(21) Appl. No.: 19/177,937

(22) Filed: Apr. 14, 2025

(51) Int. Cl. G06Q 10/10; G06F 40/18

(52) U.S. Cl. CPC G06Q 10/103; G06F 40/18

(57) ABSTRACT

In accordance with various embodiments, described herein is a system and method for use of spreadsheets integrated with web services including support for action item management. A client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities. An action items management component assists the workflow of navigation, inspection, correction, and task-tracking of action items associated with spreadsheets having large amounts of cells, to enable focus on those cells necessitating user review or action, for example to address upload results, data validations, or other issues associated with those cells.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

The present application is related to U.S. patent application titled “EDITABLE TABLE IN A SPREADSHEET INTEGRATED WITH A WEB SERVICE”, application Ser. No. 16/145,029, filed Sep. 27, 2018, and subsequently issued as U.S. Pat. No. 11,138,371 on Oct. 5, 2021; U.S. patent application titled “EDITABLE TABLE IN A SPREADSHEET INTEGRATED WITH A WEB SERVICE”, application Ser. No. 17/387,411, filed Jul. 28, 2021, and subsequently issued as U.S. Pat. No. 11,443,110 on Sep. 13, 2022; U.S. patent application titled “INTERACTIVE DATA ENTRY VALIDATION AND PROBLEM CORRECTION IN A TABLE COMPONENT IN A SPREADSHEET DRIVEN BY A WEB SERVICE”, application Ser. No. 16/145,051, filed Sep. 27, 2018, and subsequently issued as U.S. Pat. No. 11,080,476 on Aug. 3, 2021; U.S. patent application titled “INTERACTIVE DATA ENTRY VALIDATION AND PROBLEM CORRECTION IN A TABLE COMPONENT IN A SPREADSHEET DRIVEN BY A WEB SERVICE”, application Ser. No. 17/364,720, filed Jun. 30, 2021, and subsequently issued as U.S. Pat. No. 11,443,109 on Sep. 13, 2022; U.S. patent application titled “CUSTOM ACTION INVOCATION IN A SPREADSHEET INTEGRATED WITH WEB SERVICES”, application Ser. No. 16/917,384, filed Jun. 30, 2020, and subsequently issued as U.S. Pat. No. 11,848,976 on Dec. 19, 2023; and U.S. patent application titled “ORCHESTRATION OF CRUD OPERATIONS FOR A HIERARCHICAL WEB SERVICE DATA MODEL IN A SPREADSHEET”, application Ser. No. 17/008,503, filed Aug. 31, 2020, and subsequently issued as U.S. Pat. No. 11,556,702 on Jan. 17, 2023; each of which above patent applications and patents, together with the contents thereof, are herein incorporated by reference.

### TECHNICAL FIELD

Embodiments described herein are generally related to software application development, and are particularly directed to a system and method for use of spreadsheets integrated with web services including support for action item management.

### BACKGROUND

Software-based spreadsheets are a popular tool by which business users typically can access, update, and analyze their business data. To allow this, some environments allow the use of a spreadsheet to retrieve or update enterprise information via a web service.

For example, a web service can be integrated with a spreadsheet so that data may be retrieved from the web service, edited in the spreadsheet, and any changes made by a user (for example, updates, creates, deletes, or custom actions) uploaded back to the web service.

However, the management of such actions generally focuses on bulk data operations, involving large numbers of spreadsheet rows, columns, and results per row. In such environments, it is likely that some percentage of uploads may not succeed completely, and as such will not have been committed to the web service data store. Additionally, any data entry validation errors which may have been detected during the process should be corrected by the user prior to a subsequent upload.

To address this, the user may have to manually visit all rows within the spreadsheet that did not upload successfully, and inspect or correct all issues for each row, such as cells with validation errors, and then re-upload those rows. Finding the relevant spreadsheet cells takes a significant amount of effort to scroll through the potentially thousands of rows and columns in the spreadsheet.

### SUMMARY

In accordance with various embodiments, described herein is a system and method for use of spreadsheets integrated with web services including support for action item management.

A client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

An action items management component assists the workflow of navigation, inspection, correction, and task-tracking of action items associated with spreadsheets having large amounts of cells, to enable focus on those cells necessitating user review or action, for example to address upload results, data validations, or other issues associated with those cells.

### BRIEF DESCRIPTION OF THE DRAWINGS

FIG. 1 illustrates a system for use of spreadsheets integrated with web services, in accordance with an embodiment.

FIG. 2 further illustrates a system for use of spreadsheets integrated with web services, including support for a hierarchical object data model, in accordance with an embodiment.

FIG. 3 further illustrates support for a hierarchical object data model, in accordance with an embodiment.

FIG. 4 illustrates the use of spreadsheets integrated with web services, including support for custom actions, in accordance with an embodiment.

FIG. 5 further illustrates support for custom actions, in accordance with an embodiment.

FIG. 6 illustrates a system for use of spreadsheets integrated with web services including support for action item management, in accordance with an embodiment.

FIG. 7 further illustrates support for action item management, in accordance with an embodiment.

FIG. 8 further illustrates support for action item management, in accordance with an embodiment.

FIG. 9 further illustrates support for action item management, in accordance with an embodiment.

FIG. 10 illustrates an example use of the system to support action item management, in accordance with an embodiment.

FIG. 11 illustrates an example use of the system to support action item management, in accordance with an embodiment.

FIG. 12 further illustrates an example use of the system to support action item management, in accordance with an embodiment.

FIG. 13 further illustrates an example use of the system to support action item management, in accordance with an embodiment.

FIG. 14 illustrates a process for supporting action item management, in accordance with an embodiment.

### DETAILED DESCRIPTION

Software-based spreadsheets are a popular tool by which business users typically can access, update, and analyze their business data. To allow this, some environments allow the use of a spreadsheet to retrieve or update enterprise information via a web service.

For example, a web service can be integrated with a spreadsheet so that data may be retrieved from the web service, edited in the spreadsheet, and any changes made by a user (for example, updates, creates, deletes, or custom actions) uploaded back to the web service.

However, the management of such actions generally focuses on bulk data operations, involving large numbers of spreadsheet rows, columns, and results per row. In such environments, it is likely that some percentage of uploads may not succeed completely, and as such will not have been committed to the web service data store. Additionally, any data entry validation errors which may have been detected during the process should be corrected by the user prior to a subsequent upload.

To address this, the user may have to manually visit all rows within the spreadsheet that did not upload successfully, and inspect or correct all issues for each row, such as cells with validation errors, and then re-upload those rows. Finding the relevant spreadsheet cells takes a significant amount of effort to scroll through the potentially thousands of rows and columns in the spreadsheet.

In accordance with various embodiments, described herein is a system and method for use of spreadsheets integrated with web services including support for action item management.

A client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

An action items management component assists the workflow of navigation, inspection, correction, and task-tracking of action items associated with spreadsheets having large amounts of cells, to enable focus on those cells necessitating user review or action, for example to address upload results, data validations, or other issues associated with those cells.

For the purposes of the present discussion, a server may be any computing resource, such as a computer and/or software that is adapted to provide content, e.g., data and/or functionality, to another computing resource or entity that requests it, i.e., the client. A client may be any computer or system, including software system that is adapted to receive content from another computer or system, called a server. A server system may be any collection of one or more servers and accompanying computing resources. The terms “client device” and “client” may be employed interchangeably herein, however, depending upon the context in which the term is used, the term client may refer more generally to both client devices and client software.

A computing environment may be any collection of computing resources used to perform one or more tasks involving computer processing. A computer may be any processor in communication with a memory. A computing resource may be any component, mechanism, or capability or quantities thereof of a computing environment, including, but not limited to, processors, memories, software applications, user input devices, and output devices, servers, and so on. Examples of computing resources include data and/or software functionality offered by one or more web services, Application Programming Interfaces (APIs), etc.

An enterprise computing environment may be any computing environment used for a business or organization. An example enterprise computing environment includes various computing resources distributed across a network and may further include private and shared content on Intranet Web servers, databases, files on local hard discs or file servers, email systems, document management systems, portals, and so on.

A given software application may include (but not necessarily) constituent software applications or modules (e.g., services, functions, procedures, computing objects, etc.). Accordingly, the term “software application” may also include networked software applications or integrated groups thereof.

For the purposes of the present discussion, a software system may be any collection of computing resources implementing machine-readable instructions, i.e., computer code. Accordingly, the term “software system” may refer to a software application, and depending upon the context in which the term is used, may further refer to the accompanying computer(s) and associated computing resources used to run the software application.

Depending upon the context in which the term is used, a software system may further include hardware, firmware, and other computing resources enabling running of the software application. Note that certain software systems may include collections of disparate services, which are implemented in particular sequences in accordance with a process template and accompanying logic. Accordingly, the terms “software system,” “system,” and “software application” may be employed interchangeably herein to refer to modules or groups of modules or computing resources used for computer processing.

For the purposes of the present discussion, a web service may be any computer code and associated functionality that is adapted to be called by an application or other service or process whose code is stored in a separate location (e.g., on another computer or memory storage location or device) from the web service. Accordingly, the term “service” as used herein is relatively broad and may include remotely accessible APIs and services characterized by Web Services Description Language (WSDL) interfaces, Simple Object Access Protocol (SOAP), REpresentational State Transfer (REST), YAML (Yet Another Markup Language), and/or other types of interfaces.

Generally, web services, also simply called services herein, provide functionality, e.g., capabilities, that may be reused by different applications, processes, or web services (that may be distributed across a network), which access the functionality via a service interface (e.g., WSDL interface) consistent with a description of the web service. A web services model may represent a loosely coupled integration model for allowing flexible integration of various network-distributed applications or processes.

Embodiments discussed herein generally related to systems and methods for using software (called client-side software herein) running on a desktop computer, mobile device, or other computer system to authenticate with and access data, update, or otherwise use any functionality provided by web services, e.g., REpresentational State Transfer (REST) services or Application Programming Interfaces (APIs).

For the purposes of the present discussion, a custom action may be any software action implemented via code that has been developed or modified for a particular customer. Depending upon the context in which the term is used, the term custom action may refer to the software action or the code that implements the software action.

A software action may be any process or collection of processes or operations implemented via software. Additional examples of processes include updating or editing data in a database, placing a product order, creating an opportunity business object, creating a business contact object, adding a revenue line to a business object, displaying data visualizations or analytics, triggering a sequence of processes, launching an enterprise software application, displaying a dialog box, implementing a step of a process-based software application and so on. The terms “software action” and “action” are employed interchangeably herein.

Certain embodiments discussed herein are particularly useful for enabling use of client-side spreadsheets, such as Microsoft Excel, to provide input (including bulk input and implementing bulk operations) to server-side process-based software applications, thereby launching/driving the process-based software applications.

A spreadsheet may be any software application, such as Microsoft Excel, or other spreadsheet, for facilitating organization and use of data via tables. Depending upon the context in which the term is used, a spreadsheet may also refer to a document produced by the software application, or may refer to a table shown in a UI display screen of the software application. Alternatively, the term worksheet may refer to particular tables or sections of a spreadsheet UI. A workbook may refer to a collection of one or more worksheets.

Although reference may be made to specific types of spreadsheet programs, e.g., Microsoft Excel, it should be apparent that features of the embodiments can be adapted for use with any suitable spreadsheet program.

A process-based software application may be any software application definable by one or more sequences of steps, also called software activities. A sequence of steps (e.g., as may be involved in an approval flow, for instance) of a process-based software application may be called a process flow. Process flows are often modeled and illustrated via swim lanes in a User Interface (UI) display screen. Process-based applications are often implemented via composite applications that may leverage different web services for different process steps.

Software functionality may be any function, capability, or feature, e.g., stored or arranged data, that is provided via computer code, i.e., software. Generally, software functionality may be accessible via use of a user interface and accompanying user interface controls and features. Software functionality may include actions, such as retrieving data pertaining to a computing object (e.g., business object); performing an enterprise-related task, such as promoting, hiring, and firing enterprise personnel, placing orders, calculating analytics, launching certain dialog boxes, performing searches, and so on.

For clarity, certain well-known components, such as the Internet, hard drives, processors, power supplies, routers, Internet Service Providers (ISPs), workflow orchestrators, process schedulers, identity management clouds, process clouds, certificate authorities, business process management systems, database management systems, middleware, and so on, are not necessarily explicitly called out in the figures. However, those skilled in the art with access to the present teachings will know which components to implement and how to implement them to meet the needs of a given implementation.

Spreadsheet Interfaces Integrated with Web Services

In accordance with an embodiment, a client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

In accordance with various embodiments, the system can include or utilize some or all of the following features:

Integrated Workbook—a software application document that contains metadata that the software extension or add-in component can use to interact with a web service or integration environment, including a layout metadata that defines one or more graphical user interface layouts associated with the workbook. For example, in accordance with an embodiment, a workbook can be provided as a spreadsheet-type document.

Worksheet—a component of a workbook. For example, in accordance with an embodiment, a workbook can be provided as a spreadsheet-type document, and can include one or more worksheet tabs, each having one or more spreadsheets.

Business Object—a web service or other type of service or object, that can be provided within an integration environment and allows operations (e.g., GET, POST, PATCH, or DELETE operations) on a particular resource or object type. For example, in accordance with an embodiment, an expense reports object can be provided that allows operations to create or edit expense reports.

Layout—a binding of a business object to a worksheet, as defined by a workbook metadata, for purposes of allowing operations on the business object. For example, in accordance with an embodiment, a spreadsheet-type document can be associated with a table layout that operates as a binding that allows editing of invoices via a tabular invoice worksheet and an associated web service.

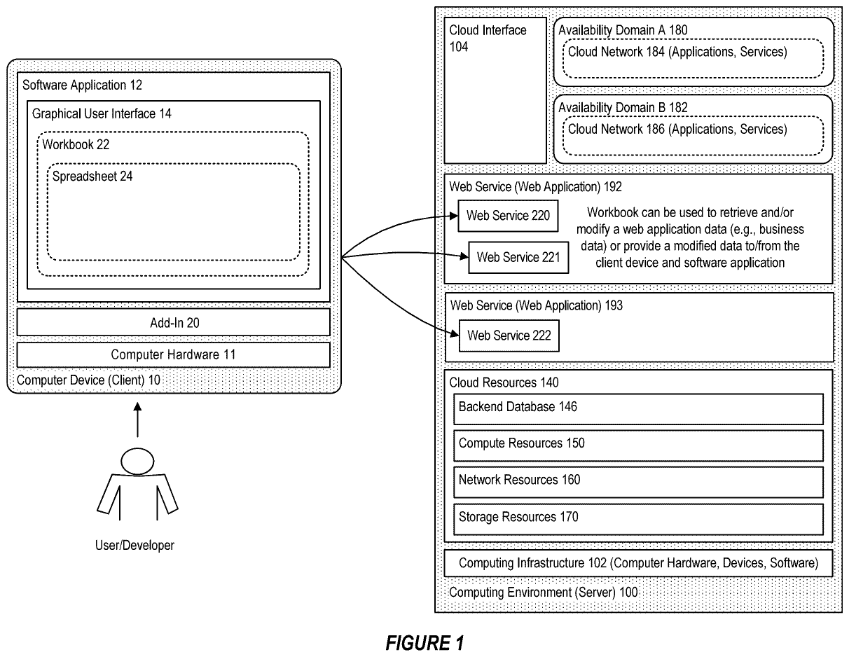

FIG. 1 illustrates a system for use of spreadsheets integrated with web services, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The examples illustrated therein are provided for purposes of illustrating a computing environment that can provide use of spreadsheets integrated with web services. In accordance with other embodiments, the various components, processes, and automated features described herein can be used with other types of computing environments.

As illustrated in FIG. 1 in accordance with an embodiment, a computing environment (e.g., a cloud environment, or server) 100 can operate on a computing infrastructure 102 comprising hardware (e.g., processor, memory), software resources, and provide a cloud interface 104 or other application program interface (API) that provides access to shared resources 140, such as, for example, a compute resources layer 150, a network resources layer 160, and/or a storage resources layer 170.

In accordance with an embodiment, the computing environment can support the use of availability domains, such as for example availability domains A 180, B 182, which enables customers to create and access cloud networks 184, 186, and run cloud instances.

In accordance with an embodiment, a client device, such as, for example, a computing device 10 having a device hardware 11 (e.g., processor, memory), a software application 12 (e.g., a spreadsheet application), and graphical user interface 14, can enable a user to communicate with the computing environment via network such as, for example, a wide area network, local area network, or the Internet, to access various applications, e.g., enterprise applications, including creating one or more workbook 22 or spreadsheet 24.

In accordance with an embodiment, web services 220, 221, 222 operate to receive requests directed to one or more web applications 192, 193.

For example, in accordance with an embodiment, a client device having a software application and graphical user interface can use a workbook or a software application document, for example a spreadsheet-type document, or other type of application document, to access a business object or web service to retrieve and/or provide a modified data to/from a web application.

In accordance with an embodiment, the web service can be, for example, a REST-based service, or other type of web service provided within an integration environment, that allows operations (e.g., GET, POST, PATCH, or DELETE operations) on a particular resource or object type (e.g., an expense reports object).

For example, in accordance with an embodiment, a business object can be provided and made accessible as a web service by an underlying service framework such as, for example, an Oracle REST Data Services environment, or a NetSuite environment, or other environment that allows client devices to communicate via web services and perform operations on associated business objects.

In accordance with an embodiment, a service-interface add-in 20 for use in software development can be provided, for example, as a software extension or add-in component, which operates both as a design tool, and as a runtime process, for purposes of integrating use of spreadsheets with web services.

In accordance with an embodiment, examples of software application environments can include spreadsheet-type software application or integration environments that can use workbooks, such as, for example, a Microsoft Excel or other type of spreadsheet-type software application.

In accordance with an embodiment, examples of software extension or add-in components can include, for example, an Oracle Visual Builder environment, configured as described herein, and which can be provided for use with a software application development environment, for purposes of developing workbooks.

In accordance with an embodiment, the workbook can be a software application document, for example a spreadsheet-type document, or other type of application document, that contains a catalog metadata that the software extension or add-in component can use to interact with a web service or other integration environment (for example, a REST-based service, or other type of web service), on behalf of a business user, together with a layout metadata that defines one or more graphical user interface layouts associated with the workbook.

In accordance with an embodiment, within a workbook, each layout provides a binding of a business object to a worksheet, as defined by a workbook metadata, for purposes of allowing operations on the business object, and integrating use of the spreadsheet with one or more web services.

In accordance with an embodiment, each workbook (e.g., spreadsheet-type document, or other type of software application document) can be considered a stand-alone application; with its only dependencies being its associated web service, the software application environment (e.g., a Microsoft Excel or other type of spreadsheet-type software application environment), and the software extension or add-in component.

In accordance with an embodiment, the add-in works directly with the web service to fetch and update data for the business user. Integrated workbooks are self-contained in that the required metadata is contained within the workbook, and can be distributed via various channels, for example via a Customer Connect channel, or embedded in web applications. Software application developers, information technology consultants, and customers can install the add-in, to design, create and test spreadsheet integrations directly on their desktop, with no dependency on another IDE or development environment.

In accordance with an embodiment, the layout forms a basis for integration of the web service (e.g., a business object) and the worksheet; and defines the aspects of the integration. For example, it can contain the set of desired table columns and their order; which of the available operations are enabled; or search/filter criteria used at data download time. A workbook can have multiple worksheets; and each worksheet can have a single layout.

In accordance with an embodiment, a client device can interrogate a web service to obtain web service metadata that determines one or more capabilities of that web service. For example, a client device 10 can send a request to a web service 220 requesting metadata, in response to which the web service can provide metadata describing which services, resources, or business objects that web service provides. The add-in can then use this information to configure a worksheet with a layout, for example to configure a spreadsheet-type document with a corresponding table component, based on the web service metadata. The table component can then be used to retrieve, display, edit, or communicate data within a spreadsheet, and upload user-made changes back to the web service.

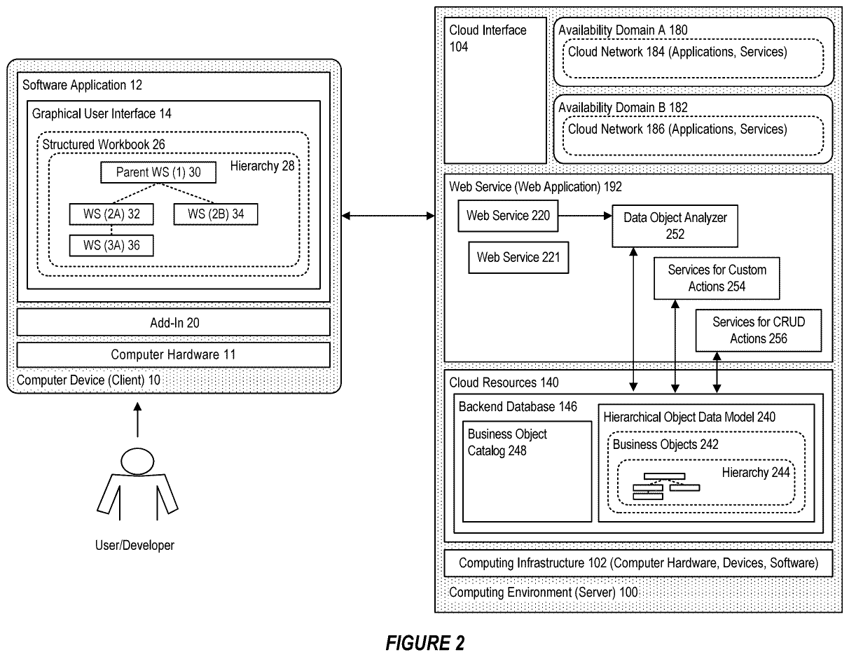

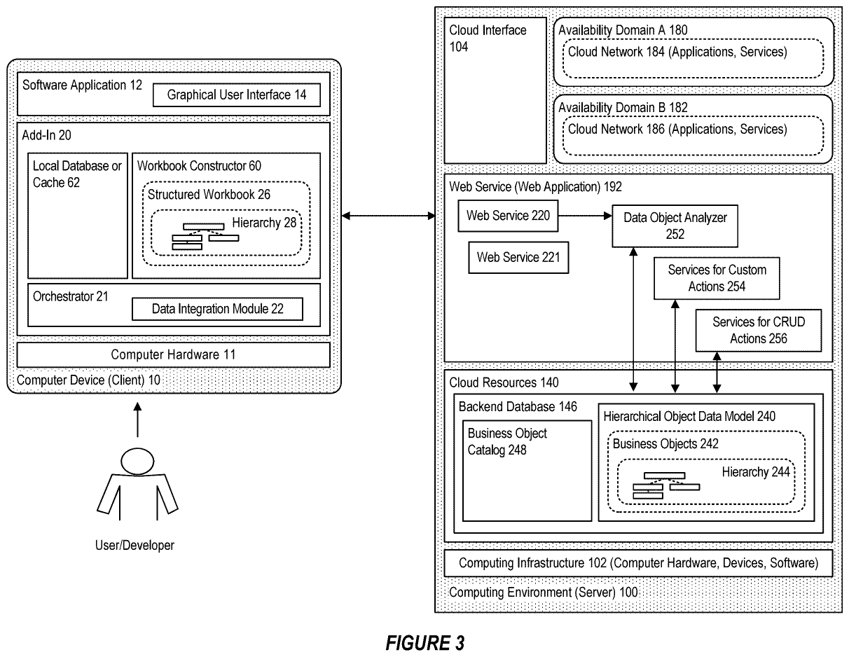

FIGS. 2 and 3 further illustrate a system for use of spreadsheets integrated with web services, including support for a hierarchical object data model, in accordance with an embodiment.

In accordance with an embodiment, FIG. 2 illustrates an example system and accompanying computing environment employing a client-side spreadsheet and accompanying service-interface add-in to interact with web services or Application Programming Interfaces (APIs) to facilitate operations, e.g., CRUD operations, on multi-dimensional hierarchically structured server-side data (e.g., corresponding to a hierarchical object data model 240) using a similarly multi-dimensional hierarchically related arrangement of spreadsheets (e.g., corresponding to a hierarchy of worksheets).

The example system includes one or more client systems (e.g., desktop computer, mobile device, etc.) in communication with a server system via a network, such as the Internet. The server system communicates with one or more backend databases 146. The server system runs one or more web services or APIs, which facilitate interaction between the one or more client systems and data and functionality maintained or provided via the backend databases.

The example client system(s) includes a spreadsheet (also called the client-side spreadsheet) with a service-interface add-in 20 and structured workbook 26.

The example web services (also called cloud-based services) of the server system include a data object analyzer 252, one or more services for facilitating implementing custom actions 254, and one or more services 256 for facilitating implementing CRUD operations.

The example backend databases include a business object catalog 248 and one or more hierarchical object data models (also called data structures herein).

Note that in general, groupings of various modules of the system are illustrative and may vary, e.g., certain modules may be combined with other modules or implemented inside of other modules, or the modules may otherwise be distributed differently (than shown) among a network or within one or more computing devices or virtual machines, without departing from the scope of the present teachings. For example, while the backend databases are shown separately from the server system, the backend databases may be part of the server system, without departing from the scope of the present teachings.

For instance, while the business object catalog and hierarchical object models may be implemented by a relational database that is used for persistence of the hierarchical object data models and accompanying data, other embodiments are possible. For instance the business object catalog hierarchical object data models may be implemented in the server system, e.g., via one or more web services and/or APIs and/or other module in communication therewith.

For example, a separate box (i.e., separate from the web services or APIs) may represent a module that incorporates functionality for communicating with, managing, and/or exposing the business object catalog and accompanying hierarchical object data models to the one or more client systems. The backend database(s) may influence the hierarchy, but, alternatively, may be used only for storage of data. Accordingly, in this example case, the business object data models and accompanying hierarchies can be implemented, in whole or in part, via one or more modules running on the server system.

In the example embodiment, the backend databases include business objects 242 that are hierarchically related in accordance with the hierarchical object data model; graphically depicted here via a data hierarchy 244. For instance, a given parent object may have one or more child objects (called children), and the children may also have one or more child objects.

The client-side structured workbook of the spreadsheet has been configured with client-side hierarchy 28 of worksheets, including a parent worksheet (WS) 30, a first child worksheet (WS 2a) 32, a second child worksheet (WS 2b) 34, and a grandchild worksheet (WS 3a) 36. These worksheets of the structured workbook have been associated, related, or otherwise linked to each other to establish the client-side hierarchical structure.

Associations, relations, or links between the worksheets and construction of the worksheets can be automatic and/or manual. During automatic configuration, the service-interface add-in obtains or accesses information about the server-side hierarchical object data model and accompanying business objects and hierarchical relationship structure (also called server-side hierarchy herein).

The service-interface add-in may obtain this descriptive information describing the server-side hierarchy and associated business object model responsive to one or more request messages sent by the service-interface add-in to the data object analyzer.

The data object analyzer may be a service that selectively accesses a business object catalog, which contains descriptive information, e.g., descriptions of business object hierarchies and data models, of the backend databases. The descriptive information can include relationship keys describing, for instance, how each of the hierarchically related business objects are related to each other (e.g., parent object, child object, sibling object, grandchild object, and so on).

The data object analyzer then delivers a response message with the descriptive information to the service-interface add-in responsive to the request message issued therefrom. The service-interface add-in includes code for automatically constructing the structured workbook and generating the initial worksheets.

The worksheets are then related to each other so that the worksheet hierarchy models a portion of, e.g., a subset of, (or all of, depending upon a given implementation) server-side hierarchy. Hence, the structure of the worksheet hierarchy (also called client-side hierarchy herein) matches a portion of the structure that includes data objects with data corresponding to data of the worksheets at similar levels of the data structure 240.

Note that the service-interface add-in may include computer code for controlling certain UI functionality of the spreadsheet. For instance, during manual structuring of relationships among the worksheets, a user may access one or more menus for selecting parent worksheets for given worksheets, and so on.

The service-interface add-in may control the availability of certain user options in such menus. For instance, the service-interface add-in may reference knowledge of the server-side hierarchy (244) to ensure that inappropriate relationships between the worksheets are not established, i.e., menu options for such are not provided during a manual configuration mode.

Structuring relationships between the worksheets in accordance with the server-side hierarchy, which characterizes the hierarchically related business objects of the hierarchical object data model, facilitates consistent interaction, synchronization, orchestration, including CRUD operations, which can now readily be implemented across complex data object hierarchies via a user-friendly UI of the spreadsheet.

In accordance with an embodiment, FIG. 3 illustrates additional detail of the service-interface add-in of the spreadsheet of the example system and accompanying computing environment of FIG. 2.

In accordance with an embodiment, the example service-interface add-in includes an example workbook constructor module 60 in communication with the web services, and in particular, the data object analyzer thereof. The workbook constructor includes code for selectively calling the data analyzer to obtain information about the hierarchical object data model and accompanying hierarchically related business objects, in addition to information about the server-side hierarchy itself, including relationships between constituent objects and sub-objects thereof.

The data object analyzer may include code for checking the business object catalog for suitable descriptions of the hierarchical object data model, and then retrieving the descriptions, so as to fulfill requests for such descriptions (which may include relationship keys identifying and describing relationships between different objects of the hierarchical object data model issued by the client-side workbook constructor.

The descriptions of the objects of the hierarchical object data model and accompanying objects and hierarchies can then be stored in a local database or cache for use by the workbook constructor 60 when constructing the worksheet hierarchy for use with the structured workbook and accompanying spreadsheet program of FIG. 2.

When building the worksheet hierarchy, the workbook constructor uses the information describing the data model (e.g., as may be obtained from the data object analyzer and business object catalog, or as may be retrieved from the local database or cache if already stored there) to construct the worksheet hierarchy using descriptive parameters or attributes that establish hierarchical relationships between the worksheets, such that the spreadsheet hierarchy parallels or mimics a portion of the server-side hierarchy.

With reference to FIGS. 2 and 3, each of the different worksheets (30-36) may be associated with a corresponding server-side data object of the server-side hierarchically related business objects. For instance, during workbook construction by the workbook constructor, the parent worksheet and data therein may correspond to a parent object of the hierarchically related business objects. Similarly, the first child worksheet may correspond to a first child object of the parent object of the hierarchically related business objects.

The service-interface add-in includes an orchestrator module and accompanying data integration module 22. The example orchestrator 21 includes code for facilitating implementation of orchestration of operations, e.g., CRUD operations, data synchronizations, implementation of custom actions (e.g., using data/parameters input from the spreadsheet), and so on, between the client-side spreadsheet and the server-side hierarchical object data model, via strategic use of the web services.

Furthermore, in the example embodiment, the orchestrator module of the service-interface add-in communicates with the local database or cache 62 and the workbook constructor. The orchestrator includes code for performing various functions, such as determining any changes or scheduled actions to any portions of the worksheets of the worksheet hierarchy; then determining when a user has selected to implement the changes (e.g., by detecting selection of an upload button); then traversing the worksheet hierarchy to package proposed changes, actions, operations, etc. into one or more request messages.

The one or more request messages are then sent to the web services, e.g., to the one or more services for implementing CRUD operations, and/or to the one or more services for implementing custom actions.

The request messages sent from the orchestrator and accompanying data integration module to the web services may include descriptive information indicating to the web services, which particular level and which particular business objects of the server-side hierarchy is/are to be operated on in accordance with the one or more request messages issued by the orchestrator and/or accompanying data integration module.

The web services may return status information, e.g., indicating whether or not a particular operation or action was successfully completed or not. This status information may then be subsequently displayed in the workbook and associated spreadsheets (30-36).

The orchestrator may also access the local database or cache to determine descriptive information of the server-side hierarchically related business objects and the client-side hierarchy of worksheets, and may then use that descriptive information to facilitate selectively updating the workbook and accompanying worksheets.

For instance, if the orchestrator determines that a user would like to download data for a parent worksheet, in response to user selection of a download button, the orchestrator may determine that the parent worksheet represents a parent node worksheet. Accordingly, when issuing a request message to the services for CRUD operations, the request message issued by the orchestrator may include descriptive information specifying retrieval of data from the corresponding parent data object of the server-side hierarchy.

Also note that in certain embodiments, if a given workbook includes worksheets that have not yet been populated with data, user selection of a download button may populate all of the worksheets with corresponding data from the hierarchical object data model, and data from different objects of that object data model will be positioned into corresponding worksheets at the corresponding hierarchical level.

### Custom Actions

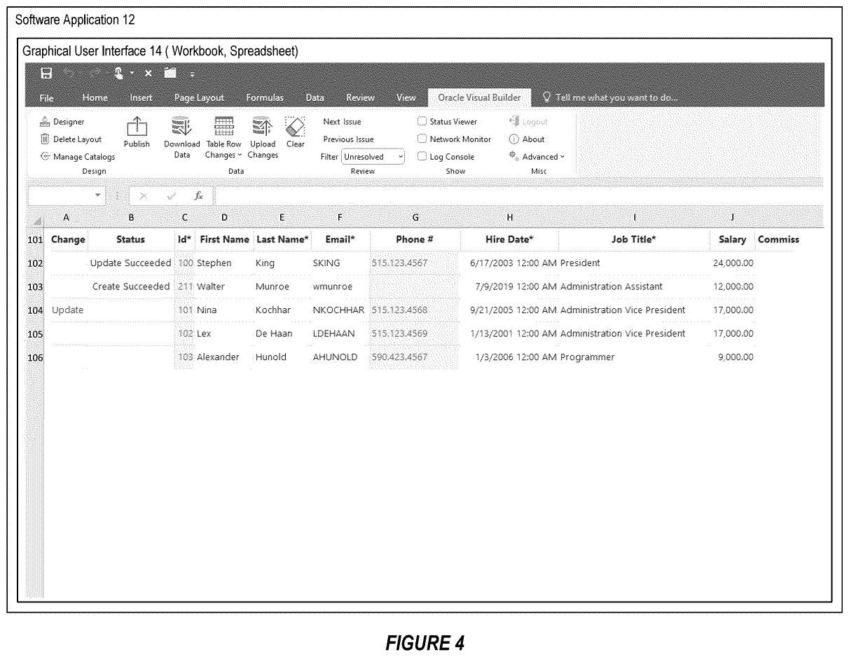

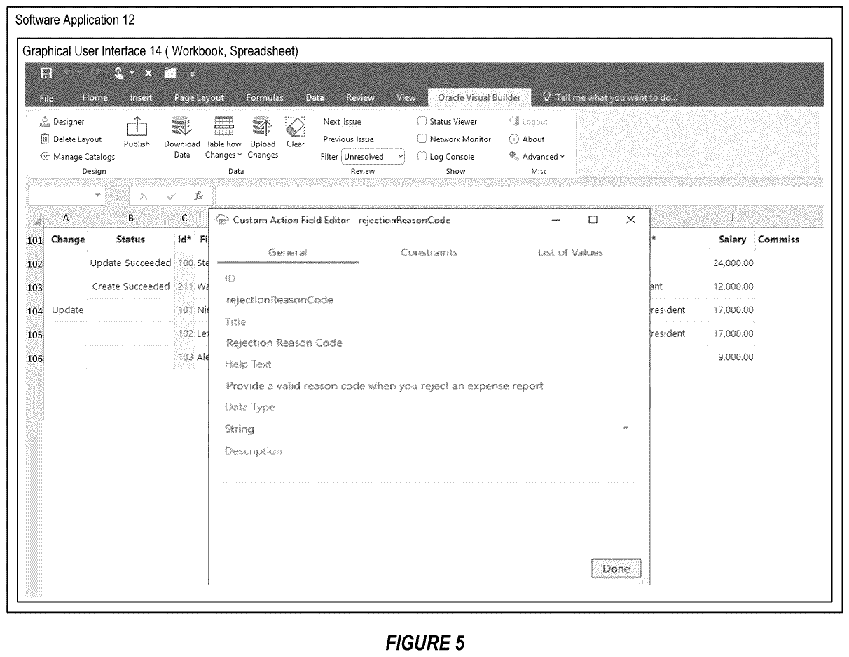

FIGS. 4 and 5 illustrate the use of spreadsheets integrated with web services, including support for (e.g., row status) custom actions, in accordance with an embodiment.

In accordance with an embodiment, a custom action is a function defined by the REST-based service that is callable by external systems using REST POST requests. The operation a custom action performs when invoked by the add-in is determined by the service. The add-in sends a POST on the collection or item path that includes the action name, such as/contextRoot/v1/myBusObj/{itemId}/action/doMyAction for a business object item.

This POST can include payload field values, known as “parameters”, to the service. The service then takes the passed parameters and performs the custom action. This action may act on a single row when defined at the row level. When the action is defined at the business object level, the REST-based service determines which rows, if any are affected.

In accordance with an embodiment, a custom action may accept zero or more parameters of simple types such as a String or Integer and returns a single value to the add-in, which is then displayed in the “Status” Viewer. This result returned by the service may be a simple scalar value like a string or a more complex non-scalar value like an array.

For example, a REST-based service may have a custom action defined at the business object (BO) level. Examples of custom actions at the BO item level might be a couple of custom actions, “Approve” and “Reject”, that operate on the items of a expense report business object. A business user can download one or more expense reports, approve or reject each one, and then update them all in a single upload.

In accordance with an embodiment, if a given REST API supports custom actions, they are described in the service's OpenAPI service metadata. The add-in can analyze this service metadata, harvest custom action definitions, and include them in the workbook's corresponding business objects.

Business users can perform custom actions using the buttons and menu commands from the Visual Builder ribbon menu/bar tab. Item level custom actions can be performed on items in either the form or the table of a Form-over-Table layout, as well as on rows in a Table layout. BO level custom actions can be performed on BOs in a Table layout and the form in a Form-over-Table layout.

As illustrated in FIGS. 4-5, in accordance with an embodiment, custom actions exposed by the service that a workbook uses can be viewed and edited in the Custom Actions tab of the Business Object Editor.

In accordance with an embodiment, the add-in populates this editor with the custom action properties as described in the service's OpenAPI service metadata.

In accordance with an embodiment, the Title, Help Text, and Description properties can be edited as needed in the Custom Action Editor. The other properties, ID, Path, and Request Media Type, reflect the service configuration.

Title: The name of this custom action. A short value that is meaningful to business users. This value appears wherever business users can invoke the action.

Help Text: A brief explanation of what the custom action does. This value appears near the title when possible.

Properties such as the Title, Data Type, and Required can be changed. For example, the user can change the data type of a payload field from String to Integer, as long as the change is compatible with the service. The user can also update the Required property to mark the payload field as required or not.

For single row custom actions, this help text appears in a popup when the business user selects the column header for a payload field in a Table layout, as shown on the left in this image:

For business object level custom actions, the help text appears in a popup when the user hovers over the Help icon next to a payload field in the Perform Action wizard, as shown on the right. The user can also configure a payload field with a custom field validation rule as well as a list of values.

In accordance with an embodiment, if the service a workbook uses includes custom actions on individual items of a business object, the user can add defined custom action payload fields to a Table layout or the table part of a Form-over-Table layout—for example, a “reject” custom action that is exposed by an expense report business object to reject expenses.

In accordance with an embodiment, if a given REST API supports custom actions, they are described in the OpenAPI service metadata generated by the ADF REST Resource service. For example, a reject item-level custom action would appear in the paths collection:

```
“/ExpenseReports/{ExpenseReports_Id}/action/reject”: {
    “parameters”: [
      {
        “$ ref”: “#/components/parameters/ExpenseReports_Id”
      }
    ],
    “post”: {
      “summary”: “reject”,
      “description”: “reject”,
      “operationId”: “do_reject_ExpenseReports”,
      “responses”: {
        “default”: {
          “description”: “The following table describes the
          default response for this task.”,
          “content”: {
            “application/vnd.adf.actionresult+json”: {
              “schema”: {
                “type”: “object”,
                “properties”: {
                  “result”: {
                    “type”: “string”
                  }
                },
                “required”: [
                  “result“
                ],
                “additionalProperties”: false
              }
            }
          }
        }
      },
      “requestBody”: {
        “description”: “The following table describes
        the body parameters
          in the request for this task. ”,
        “content”: {
          “application/vnd.adf.action+json”: {
            “schema”: {
              “type”: “object”,
              “properties”: {
                “rejectionReasonCode”: {
                  “type”: “string”,
                  “nullable”: true
                },
                “notes”: {
                  “type”: “string”,
                  “nullable”: true
                }
              } ,
              “additionalProperties”: false
            }
          }
        }
      }
    }
  }
}
```

### Action Item Management

As described above, a web service can be integrated with a spreadsheet so that data may be retrieved from the web service, edited in the spreadsheet, and any changes made by a user (for example, updates, creates, deletes, or custom actions) uploaded back to the web service.

However, the management of such actions generally focuses on bulk data operations, involving large numbers of spreadsheet rows, columns, and results per row. In such environments, it is likely that some percentage of uploads may not succeed completely, and as such will not have been committed to the web service data store.

To address this, the user may have to manually visit all rows within the spreadsheet that did not upload successfully, and inspect or correct all issues for each row, such as cells with validation errors, and then re-upload those rows. Finding the relevant spreadsheet cells takes a significant amount of effort to scroll through the potentially thousands of rows and columns in the spreadsheet.

Generally described, the management of action items associated with the data, such as reviewing upload results or performing data validations, typically focuses on bulk data operations, with many thousands of rows, hundreds of columns, and tens/hundreds of results per row, with the typical workflow following these steps:

The business user prepares a large set of changes in the spreadsheet to be uploaded to the web service: existing items from the web service may have been downloaded and edited; new items may have been created from scratch in the spreadsheet (or copy/pasted from another source); items may have been marked for deletion or custom action invocation; or any combination of the above.

Once the items are prepared for upload, the user invokes the upload operation, and all changes are sent to the web service. The web service responds with information about each of the changed items sent, such as for example: change succeeded (optionally with associated informational or warning result items); change did not succeed; or one or more failures and/or warnings.

For each failure or warning, additional details may be included, such as for example: a description message meant for the business user; an error code; or field identifier. Each detail may have nested (child) details that follow the same structure.

For a bulk upload of thousands of rows, it is expected and likely that some percentage will not succeed completely and will not have been committed to the web service data store. The business user must visit all rows that did not succeed, and inspect/correct all issues for each row (and then re-upload those rows). Finding the relevant spreadsheet cells takes a significant amount of effort to scroll through the many rows and columns in the spreadsheet.

A particular challenge for the user is to map those results or feedback from the web service back to the relevant cells in the spreadsheet (where the cell values need to be reviewed and corrected). The sparse set of affected spreadsheet cells may span thousands of rows and hundreds of columns both inside and outside of the limited set of cells visible to the user at any time in the spreadsheet.

To address this, in accordance with various embodiments, the system and method for use of spreadsheets integrated with web services includes support for action item management.

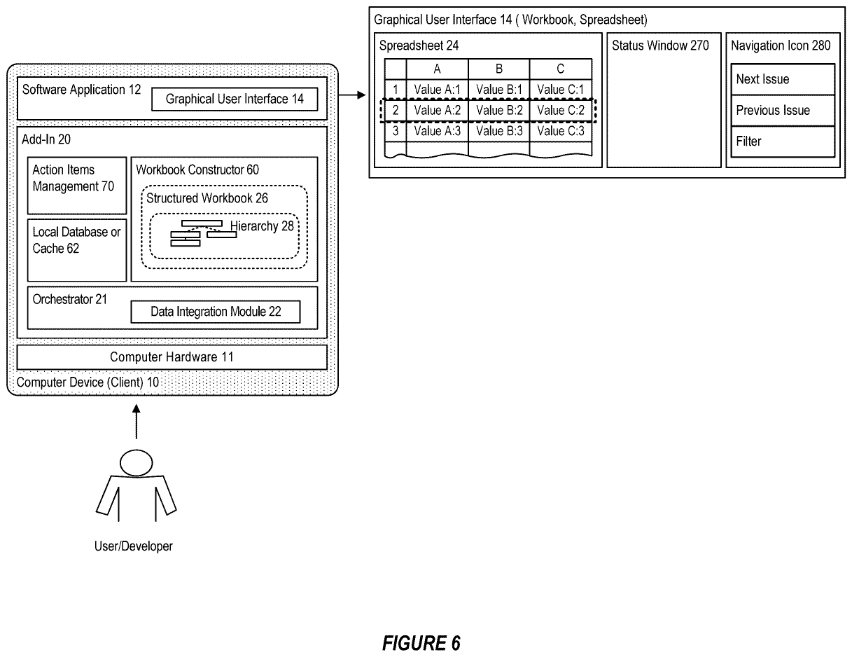

FIGS. 6-8 illustrate a system for use of spreadsheets integrated with web services including support for action item management, in accordance with an embodiment.

As illustrated in FIG. 6, in accordance with an embodiment, a client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

In accordance with an embodiment, the add-in includes an action items management component 70 that assists the workflow of navigation, inspection, correction, and task-tracking of action items associated with spreadsheets having large amounts of cells, to enable focus on those cells necessitating user review or action, for example to address upload results, data validations, or other issues associated with those cells.

In accordance with an embodiment, the described approach enables a user to navigate quickly and easily to relevant cells for efficient reviewing and correcting of action items, such as for example, the uploading of changes back to a web service (i.e., upload results), data validations, recommendations, or other functionalities. Additional features or advantages of the described approach include:

Auto-detection of corrective edits in spreadsheet to assist tracking of resolved/unresolved action items.

A means of providing a user interface icons and/or status window in the manner of a To-Do list, that assists the user in finding, managing, and filtering action items; record and report action item resolution status.

The ability to filter and focus on groups of similar action items, to perform bulk corrections.

The opportunity to support resolution workflows that span multiple spreadsheet sessions, to address the “where was I” user experience associated with traditional environments.

Given that the cells of interest after upload (those corresponding to specific errors/warnings/informational messages) may be distributed across hundreds of columns and many thousands of rows, the described approach provides a simple mechanism to navigate among the relevant cells for a set of upload results, data validations, or other issues associated with those cells. Rather than scrolling or searching through the large volume of many thousands of rows, the user can navigate to the next (or previous) action item or issue, or relevant cell with the click of a button.

For example, as illustrated in FIG. 6, a user can display, within a graphical user interface, a spreadsheet, for upload or validation against a web service.

The user interface can additionally include a status window 270 that displays information associated with cells necessitating user review or action, for example to address upload results, data validations, or other issues associated with those cells; together with a navigation icon 280, or other form of window, drop-down menu, or selectable buttons that assists the user in navigating between action items associated with the spreadsheet and the relevant cells.

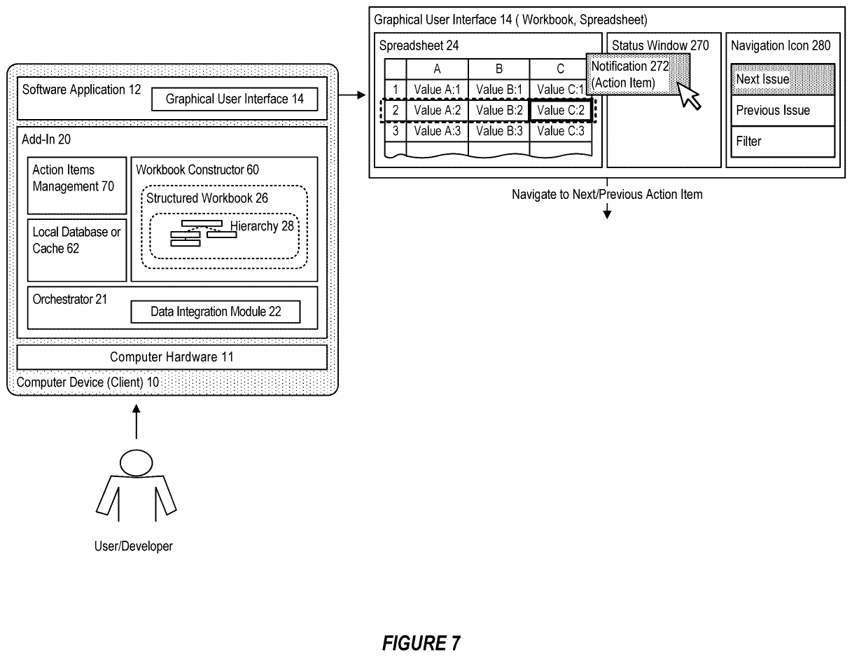

As illustrated in FIG. 7, for example, the system can generate a notification 272 indicative that a particular cell necessitates user review or action, which can be displayed alongside the cell with the cell highlighted in some manner. The user can address the issue, and click the “Next Issue” button to move to a related cell, or next cell, necessitating user review or action.

In response to the user interactions, the system automatically scrolls to and selects the cell that corresponds to the next action item (e.g., upload result, or data validation). Rather than scrolling or searching for the relevant row/cell for the next action item (e.g., upload result, or data validation), by the user clicking the “Next Issue” button causes the system to go directly to the relevant cell and allows the user to review and correct the issue.

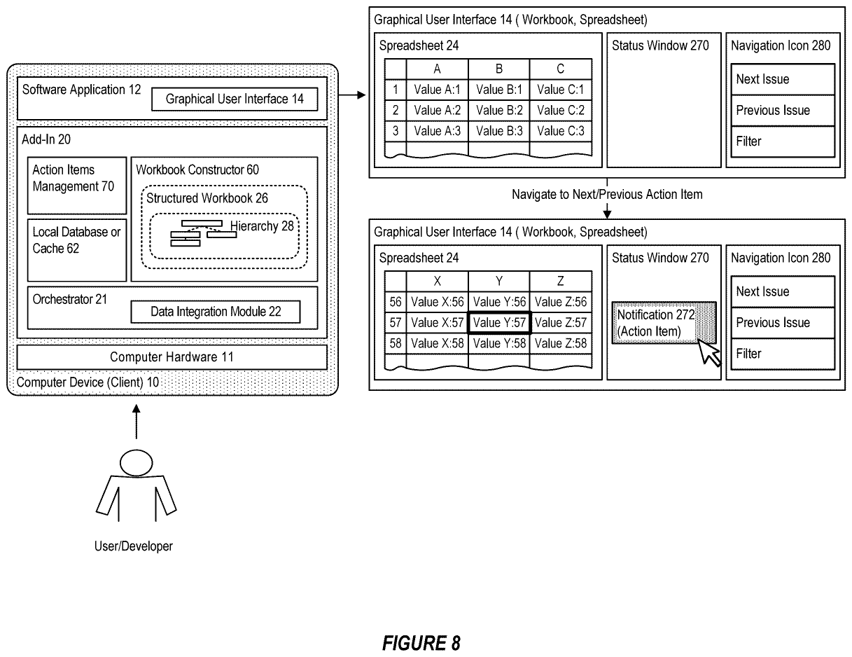

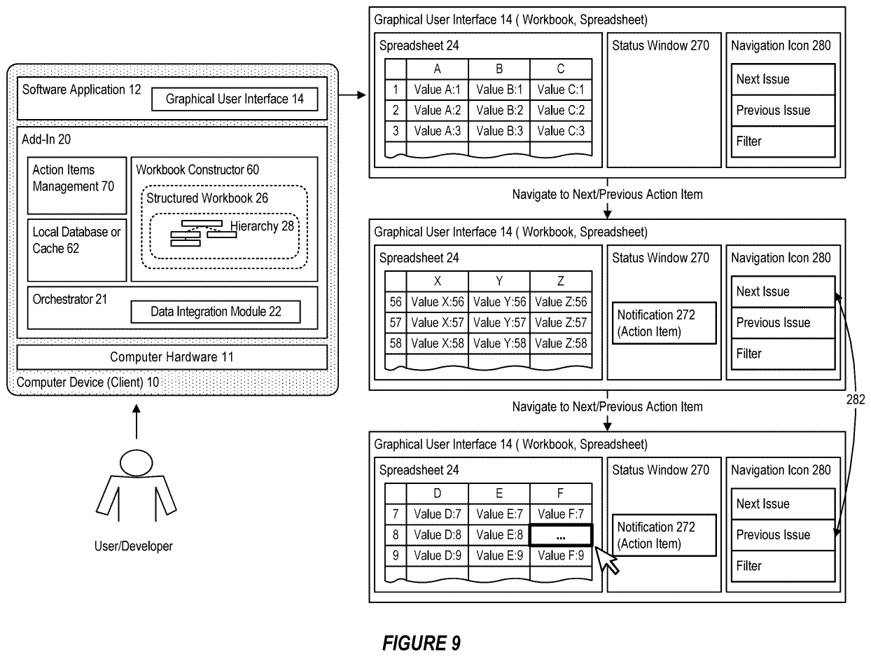

As illustrated in FIGS. 8 and 9, the system can alternatively or additionally generate the notification within the status window. In either case, the user can elect to click on the notification, or the “Next Issue” (or “Previous Issue”) button to navigate 282 between related cells, or next/previous cells necessitating user review or action, as appropriate.

### Example User Interaction

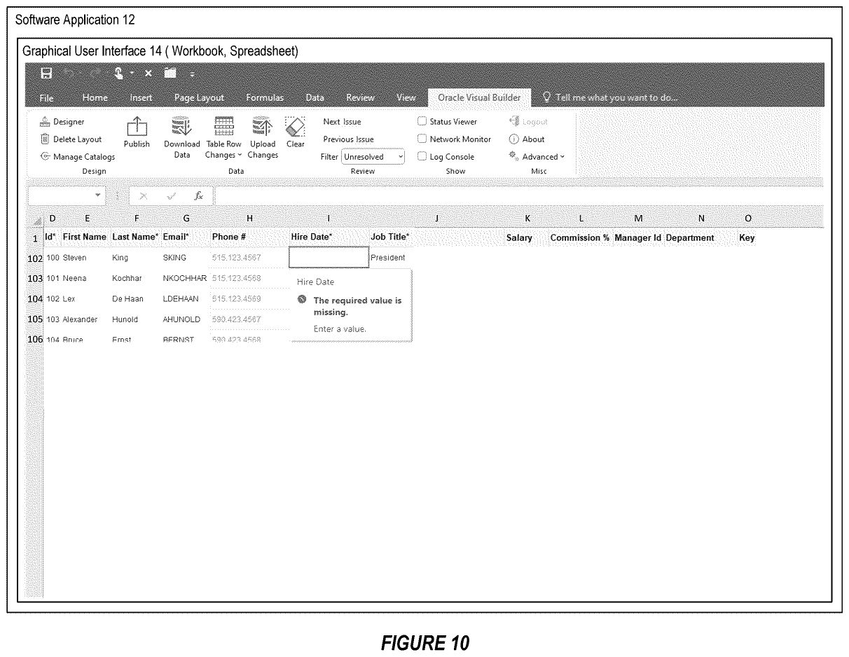

FIGS. 10-13 illustrate an example use of the system to support action item management, in accordance with an embodiment.

In the examples illustrated in FIGS. 10-13 and additional drawings herein, the data and message text is fictitious and intended as an illustrative example only. Additionally, the layout of the various user interface windows are likewise intended as an illustrative example to demonstrate the various functionalities, and that other layouts and specific mechanisms (for example, buttons, drop-down choices, or popup windows) could be used.

Issue Navigation using Ribbon Menu/Bar

As illustrated in the example of FIG. 10, in accordance with an embodiment, the user interface can include a ribbon menu/bar with navigation support for “Next Issue”, “Previous Issue”, and “Filter”.

In the illustrated example, the system determines that the currently selected cell is associated with a missing value for Hire Date. The user can resolve that issue (for example, by entering a date value) and click the “Next Issue” button on the ribbon menu/bar.

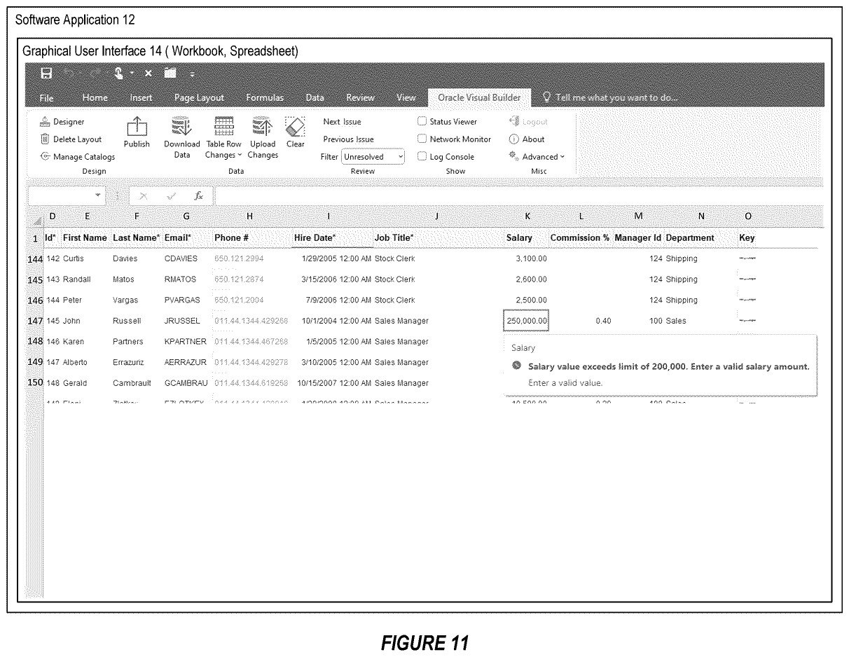

As illustrated in FIG. 11, in response to the user interactions the system automatically scrolls to and selects the (next) cell, here in row 147, column K, that corresponds to the next action item (e.g., upload result, in this example, a Salary value that is out of range).

It will be seen that, rather than scrolling or searching for the relevant row/cell for the next action item (e.g., upload result, data validation), the user clicking the “Next Issue” button causes the system to go directly to the relevant cell and allows the user to review and correct the issue.

In accordance with an embodiment, a “Filter” choice component in the ribbon menu/bar allows the user to limit the set of action items (e.g., upload results, data validations), being considered; for example, by allowing navigating through “Unresolved” issues, “Resolved” issues or “All” issues.

Excluding already-“Resolved” issues lets the business user efficiently visit just those issues that need attention. Including “Resolved” issues allows a second pass to review corrections (perhaps by a different user).

### Contextual Details Popup

In accordance with an embodiment as illustrated in FIG. 11, the system can provide specific details about an action item in context: when the cell associated with a particular issue is selected, the cell is outlined and a popup window shows the details about the particular issue, easily allowing the business user to determine what the changes are needed to correct the issue.

Issue Navigation using Status Window

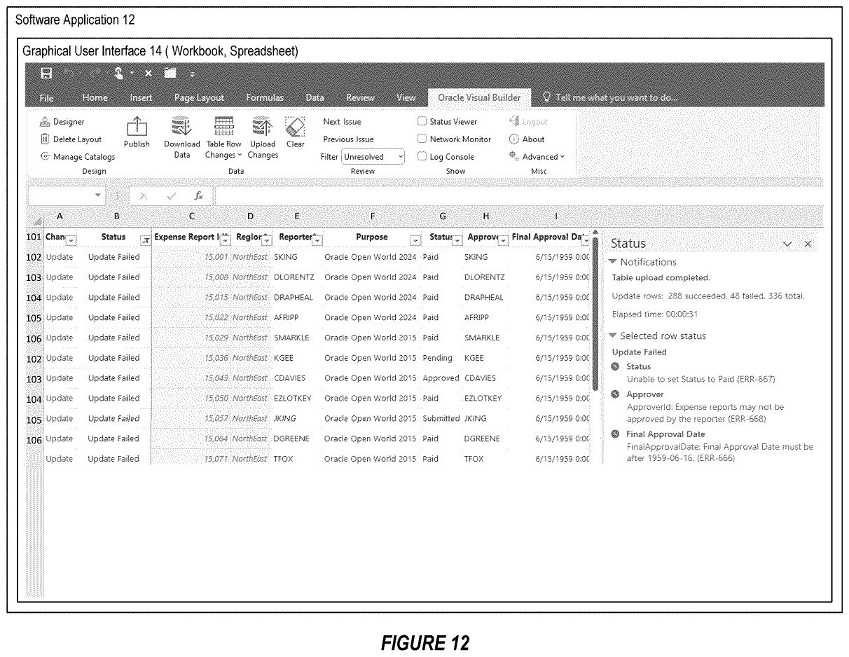

In accordance with an embodiment as illustrated in FIG. 12, the add-in can alternatively and/or additionally provide detailed information about an action item using the “Status” window. As the user changes the current row in the spreadsheet, the “Status” window shows any errors/warnings/informational messages from the last upload operation.

In accordance with an embodiment, the user can use native spreadsheet filtering features to reduce the amount of rows that were uploaded to see only those with (for example) Update failures. Each of the failed rows can be visited in turn, with the “Status” window providing details of all the issues in the row, as well as a mechanism to select the relevant cell for each issue.

For example, after an upload operation of rows, the user can filter the spreadsheet to show only the rows that failed using an “Update Failed” status value. This reduces the rows uploaded to just those that failed, and which need to be visited and corrected.

In accordance with an embodiment, the “Status” window shows a “Selected row status”, along with a list of all the issues that caused that row to fail during upload. In some instances, there could be numerous issues (for example, hundreds) that might sparsely span hundreds or thousands of columns in the row.

In accordance with an embodiment, the described approach allows scrolling to and selecting (in the spreadsheet), the relevant cell for a given upload result, data validation, or other issue associated with that cell. Each detail in the list (for example: ApprovedId: Expense reports may not be approved by the reporter) can have a navigation mechanism, which when activated (e.g., by clicking an associated hyperlink), selects the relevant cell and allows the user to quickly correct the issue, at which point they can move on to the next issue in that row (from the “Status” window), or move within the spreadsheet to the next row, and repeat the steps to resolve issues on that next row.

Direct Navigation to Cells with Issues

In accordance with an embodiment the described approach can be used to extend data entry validation features by allowing navigation (from the “Status” Window) directly to the relevant cell where the data entry validation issue can be found. This provides the business user with a consistent mechanism and user interface for navigating to a cell that needs review and correction (as with an upload result).

### Data Validation Issues

When handling large volumes of data (and long and wide spreadsheets), users frequently use bulk copy and paste from other sources to create new rows in the spreadsheet table. The add-in treats such rows as a pending Create (and will submit them to the web service for creation on the next Upload operation). The described approach allows any data entry validation errors detected by the add-in on paste to be corrected by the user prior to upload.

### Auto-Detection of Corrective Edits/Reporting Progress

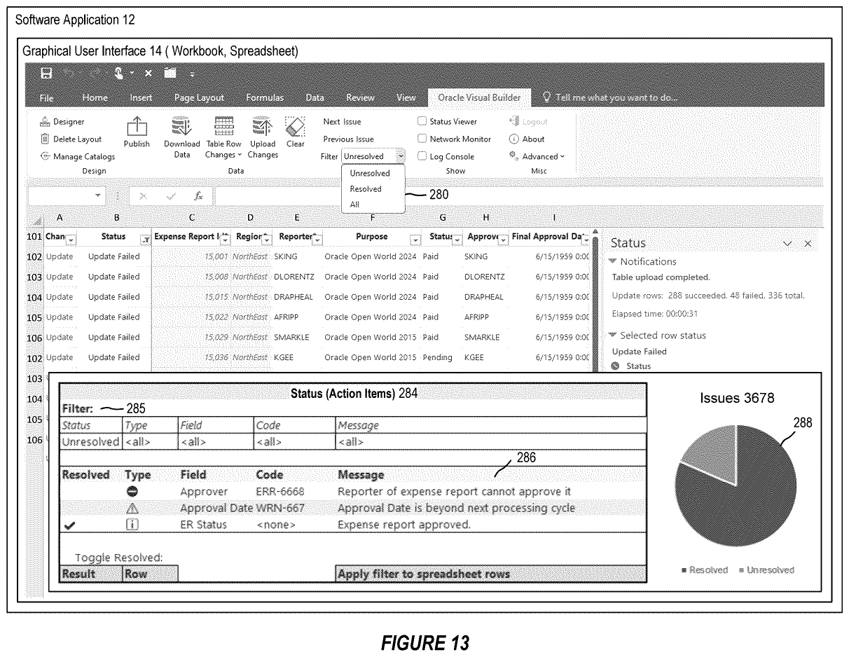

As illustrated in FIG. 13, in accordance with an embodiment, the system can detect when the business user edits a cell that corresponds to, e.g., an upload result, or a data validation, and automatically record that issue as “Resolved”, for use in generating a progress “Status” (e.g., To-Do list, Action Items) window 284.

In addition, the add-in can track when all the issues for a given row have been resolved and records that row as “Resolved”. This removes that particular issue from consideration: the row is no longer visited when the “Next Issue”/“Previous Issue” buttons are clicked (provided the “Filter” is “Unresolved”).

These “Resolved” statuses can be used when filtering 285 the To-Do list and also for providing the user with metrics of issues or work done/work remaining 286. The To-Do list (and/or “Status” window) can provide a textual or graphical representation of the progress.

For example, in accordance with an embodiment, a textual example can be provided as:

| | Total | “Resolved” | “Unresolved” |
|---|---|---|---|
| Issues | 3678 | 2999 | 679 |
| Rows | 1234 | 1000 | 234 |

As illustrated in FIG. 13, the system can alternatively and/or additionally provide the information by means of a graphical icon 288.

In accordance with an embodiment, the “Resolved” status for action items or issues, and associated rows, can be recorded and persisted when the spreadsheet is saved and closed. On re-opening the spreadsheet, the business user can pick up where they left off and continue reviewing and correcting unresolved action items (e.g., upload results, data validations).

This alleviates the user from having to rely on their memory and then potentially having to re-review all the action items, upload results, or data validations, or other issues, to determine which ones may still need resolution.

### To-Do List

In accordance with an embodiment, the “Status” (To-Do list) window appears after an upload operation, optionally either automatically if there are issues to review, or manually when requested by the business user (for example by a ribbon menu/bar command button). The window can be moved and resized by the user so that both the window and the spreadsheet are visible at the same time.

In accordance with an embodiment, the business user can apply filters to the “Issues” list. All properties of issues in the list may have filter criteria applied. For example, the Status might be “Unresolved” (or “Resolved”, or “All”). The Type can be limited to Errors, Warnings, Informational Items (or some combination). Filtering by Field, Code, Message: Allows the user to set filter criteria for these attributes, for example:

| | Contains | Appr |
|---|---|---|
| OR | Equals | Approver |
| AND | Does not Equal | Approval Status |

Similarly, the user can create complex filtering criteria for Code and Message in order to reduce the To-Do list to a specific subset of issues. This allows the user to perform bulk corrections.

In accordance with an embodiment, the add-in can analyze and automatically categorize types of issues, and then group the issues by type/category to enable the end user to focus on a given category of issue, to more efficiently resolve issues of a similar nature. For example, if there are a total of 1000 issues that can be assigned into 5 separate categories, the user might be informed that there are, e.g., 750 issues of a first type, 200 issues of a second type, 30 issues of a third type, and 10 issues of each of fourth and fifth types. The user can then decide which category to focus on, to expediently resolve all 1000 issues.

### Issues List

In accordance with an embodiment, an issues list shows all the issues that match the current “Filter” criteria. In this example, there are several (three) items visible in the “Issues” list. For each item, the list has columns to show the “Resolved” status, Type of issue (error, warning, info), relevant Field, Code (if any), and detail Message.

As the user selects an issue in the “Issues” List, the add-in automatically selects the relevant cell in the spreadsheet and scrolls it into view. This facilitates the review/correction step of the workflow.

### Resolved Button Toggle

In accordance with an embodiment, buttons that allow the business user to manually mark an action item or issue (or row) as “Resolved” or “Unresolved”. This provides the user with the ability to modify/override the state that may have been set automatically by the Auto-detection of Corrective Edits.

### Apply Filter to Spreadsheet

In accordance with an embodiment, a button can be provided that applies the current filter criteria from the To-Do List window onto the rows in the spreadsheet. This allows the user to bulk-correct certain kinds of issues across multiple rows.

Using an Apply filter to spreadsheet rows will automatically instruct the native spreadsheet row-filtering capability to show only the relevant rows. The user can bulk-correct those issues by using the native spreadsheet copy-down capability to quickly supply a value for all rows with the missing value, which is more efficient than having to navigate to the cell on each row, one at a time.

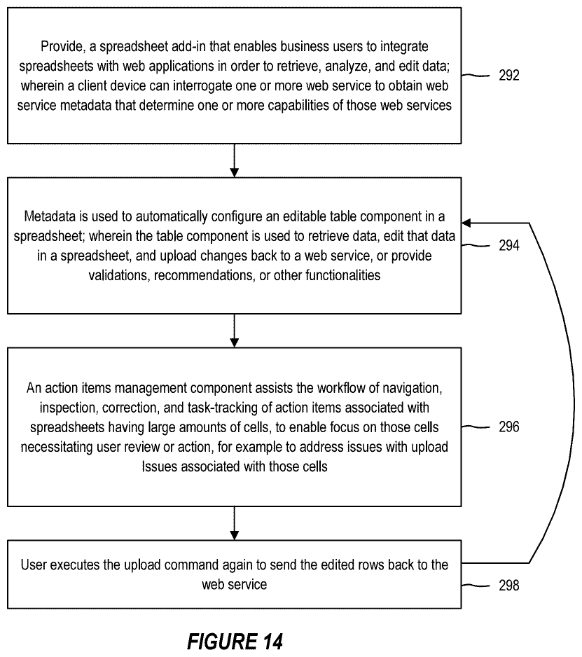

FIG. 14 illustrates a process for supporting action item management, in accordance with an embodiment.

As illustrated in FIG. 14, in accordance with an embodiment, the process or method comprises, at step 292, providing a spreadsheet add-in that enables business users to integrate spreadsheets with web applications in order to retrieve, analyze, and edit data; wherein a client device can interrogate one or more web services to obtain web service metadata that determines one or more capabilities of those web services.

At step 294, metadata is used to automatically configure an editable table component in a spreadsheet; wherein the table component is used to retrieve data, edit that data in a spreadsheet, and upload changes back to a web service, or provide validations, recommendations, or other functionalities.

At step 296, an action items management component assists the workflow of navigation, inspection, correction, and task-tracking of action items associated with spreadsheets having large amounts of cells, to enable focus on those cells necessitating user review or action, for example to address upload results, data validations, or other issues associated with those cells.

At step 298, the user executes the upload command again to send the edited rows back to the web service.

In some instances, although the user may have resolved a particular issue on their client side, the changes made by the user may not be acceptable to the web service. For example, a web service may include business logic or rules that are opaque to the add-in, and an error returned by the web service may not provide enough information for the add-in to know if the issue is completely resolved. In such instances, the user can continue to perform a navigation, inspection, correction, and task-tracking of action items, using the process described above.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

1. A system for use of spreadsheets integrated with web services including support for action item management, comprising:
a client device, including an add-in that operates as a design tool and runtime process to interrogate one or more web services to obtain web service metadata that determines one or more capabilities of those web services;
wherein the metadata is used to automatically configure an editable table component in a spreadsheet for use with a web service, wherein the table component is used to retrieve data, edit the data in the spreadsheet, or upload changes back to the web service, or provide validations, recommendations, or other functionalities; and
wherein the add-in provides navigation, inspection, correction, and task-tracking of action items associated with spreadsheets having a plurality of cells, to display within a user interface those cells necessitating user review or action, wherein following an upload or validation associated with the web service, of changes made to the spreadsheet at the client device, the add-in
generates and displays within the user interface notifications indicative that one or more cells necessitate user review or action,
wherein in response to interaction with the user interface notifications, the system provides navigation between the one or more cells that correspond to successive action items.

2. The system of claim 1, wherein the action items are one or more of upload result action items or data validations.

3. The system of claim 1, wherein a user interface can additionally include:
a status window that displays information associated with cells necessitating user review or action, to address upload results or data validations associated with those cells;
together with a navigation icon, window, drop-down menu, or selectable buttons that assists the user in navigating between action items associated with the spreadsheet and the relevant cells.

4. The system of claim 3,
wherein the system can generate a notification indicative that a particular cell necessitates user review or action, which can be displayed alongside the cell with the cell highlighted in some manner;
wherein in response to user interactions, the system automatically scrolls to and selects the cell that corresponds to a next action item or relevant cell to allow the user to review and correct the issue.

5. The system of claim 1, wherein the system is provided as part of a cloud computing system.

6. A method for use of spreadsheets integrated with web services including support for action item management, comprising:
providing, at a client device an add-in that operates as a design tool and runtime process to interrogate one or more web services to obtain web service metadata that determines one or more capabilities of those web services;
wherein the metadata is used to automatically configure an editable table component in a spreadsheet, wherein the table component is used to retrieve data, edit the data in the spreadsheet, or upload changes back to the web service, or provide validations, recommendations, or other functionalities; and
wherein the add-in provides navigation, inspection, correction, and task-tracking of action items associated with spreadsheets having a plurality of cells, to display within a user interface those cells necessitating user review or action, wherein following an upload or validation associated with the web service, of changes made to the spreadsheet at the client device, the add-in
generates and displays within the user interface notifications indicative that one or more cells necessitate user review or action,
wherein in response to interaction with the user interface notifications, the system provides navigation between the one or more cells that correspond to successive action items.

7. The method of claim 6, wherein the action items are one or more of upload result action items or data validations.

8. The method of claim 6, wherein a user interface can additionally include:
a status window that displays information associated with cells necessitating user review or action, to address upload results or data validations associated with those cells;
together with a navigation icon, window, drop-down menu, or selectable buttons that assists the user in navigating between action items associated with the spreadsheet and the relevant cells.

9. The method of claim 8,
wherein the system can generate a notification indicative that a particular cell necessitates user review or action, which can be displayed alongside the cell with the cell highlighted in some manner;
wherein in response to user interactions, the system automatically scrolls to and selects the cell that corresponds to a next action item or relevant cell to allow the user to review and correct the issue.

10. The method of claim 6, wherein the method is performed within a cloud computing system.

11. A non-transitory computer readable storage medium having instructions thereon, which when read and executed by a computer cause the computer to perform a method comprising:
providing, at a client device an add-in that operates as a design tool and runtime process to interrogate one or more web services to obtain web service metadata that determines one or more capabilities of those web services;
wherein the metadata is used to automatically configure an editable table component in a spreadsheet, wherein the table component is used to retrieve data, edit the data in the spreadsheet, or upload changes back to the web service, or provide validations, recommendations, or other functionalities; and
wherein the add-in provides navigation, inspection, correction, and task-tracking of action items associated with spreadsheets having a plurality of cells, to display within a user interface those cells necessitating user review or action, wherein following an upload or validation associated with the web service, of changes made to the spreadsheet at the client device, the add-in
generates and displays within the user interface notifications indicative that one or more cells necessitate user review or action,
wherein in response to interaction with the user interface notifications, the system provides navigation between the one or more cells that correspond to successive action items.

12. The non-transitory computer readable storage medium of claim 11, wherein the action items are one or more of upload result action items or data validations.

13. The non-transitory computer readable storage medium of claim 11, wherein a user interface can additionally include;
a status window that displays information associated with cells necessitating user review or action, to address upload results or data validations associated with those cells;
together with a navigation icon, window, drop-down menu, or selectable buttons that assists the user in navigating between action items associated with the spreadsheet and the relevant cells.

14. The non-transitory computer readable storage medium of claim 13,
wherein the system can generate a notification indicative that a particular cell necessitates user review or action, which can be displayed alongside the cell with the cell highlighted in some manner;
wherein in response to user interactions, the system automatically scrolls to and selects the cell that corresponds to a next action item or relevant cell to allow the user to review and correct the issue.

15. The non-transitory computer readable storage medium of claim 11, wherein the method is performed within a cloud computing system.
